(19) United States
(12) Patent Application Publication
(10) Pub. No.: US 2003/0070064 A1
(43) Pub. Date: Apr. 10, 2003

(54) Circuit and method capable of adjusting the external clock of a CPU

(76) Inventor: Te-Yu Liang, Taipei (TW)

Correspondence Address: RABIN & BERDO, P.C., Suite 500, 1101 14th Street, N.W., Washington, DC, 20005, US

(21) Appl. No.: 10/053,573

(22) Filed: Jan. 24, 2002

(30) Foreign Application Priority Data
Oct. 9, 2001 (TW) 90125022

(51) Int. Cl. G06F 15/177

(52) U.S. Cl. 713/2

(57) ABSTRACT

A circuit and a method capable of adjusting the external clock of a CPU are disclosed. When needed, the computer user can adjust the external clock by inputting an external-clock value (for example, 66 or 33) via the keyboard. The keyboard controller feeds the control signal, corresponding to the external-clock value, into the external-clock storage device to store the external-clock value. Next, the south bridge circuit shuts down the computer system. And the wake-up circuit wakes up the south bridge circuit in a wake-up time (for example, one second) to reboot the computer system. Afterward the external-clock storage device feeds the external-clock value into the clock generator and the clock generator provides the CPU with the external clock according to the external-clock value.

### BACKGROUND OF THE INVENTION

This application incorporates by reference Taiwanese application Serial No. 90125022, Filed Oct. 9, 2001.

2. Field of the Invention

The invention relates in general to an external-clock adjusting circuit of a central processing unit (CPU) and the operative method thereof, and more particularly, to a method and hardware implementation of adjusting an external clock of a CPU by a basic input/output system (BIOS) or an application.

2. Description of the Related Art

In the past few years, the development of the computer technology has been very vigorous. Because of its high mobility, the notebook computer has become an indispensable tool for the business individual. When working outside the office, the sustaining power of a notebook computer's battery determines the usage time of the notebook computer. Due to the limited capacity of the battery, it is very important to minimize power consumption in order to increase the usage time of the notebook computer.

### SUMMARY OF THE INVENTION

It is therefore an object of the invention to provide a circuit and a method for adjusting the external clock of a CPU in order to increase the power efficiency.

The invention achieves the above-identified object by providing a circuit and a method for adjusting the external clock of the CPU. When the computer user finds it necessary to adjust the external clock, the user can input an external-clock value (for example, 66 or 33) by means of the keyboard. The keyboard controller then feeds the control signal, corresponding to the external-clock value, into the external-clock storage device to store the external-clock value. Next, the south bridge circuit shuts down the computer system. And the wake-up circuit wakes up the south bridge circuit in a wake-up time (for example, one second) to reboot the computer system. Afterward the external-clock storage device feeds the external-clock value into the clock generator and the clock generator provides the operative requirement of the CPU, with the external clock set according to the external-clock value.

### BRIEF DESCRIPTION OF THE DRAWINGS

Other objects, features, and advantages of the invention will become apparent from the following detailed description of the preferred but non-limiting embodiments. The description is made with reference to the accompanying drawings, in which:

FIG. 1 is a block diagram of a circuit for adjusting the external clock of a central processing unit according to a preferred embodiment of the invention.

### DESCRIPTION OF THE PREFERRED EMBODIMENT

Currently, the development of more advanced and powerful notebook computers is marked by the higher clock speed of the central processing unit (CPU) of the notebook computer. Now, the portable notebook computer not only can execute general document-processing jobs, but also possesses the ability for processing multimedia and image data. The functions of the notebook computer have become increasingly powerful, corresponding to the technology of more powerful CPUs. Regarding the current technology, the clock of a CPU is determined by the product of the external clock and the clock multiplier factor. For example, if the clock multiplier factor is 8 and the external-clock value is 100 MHz, the clock of the CPU is equal to the product of 8 and 100 MHz, that is, 800 MHz. The idea of the invention is that when it is not necessary for the notebook computer to execute high speed operating jobs, the external clock of the CPU can be decreased to make the CPU work at a lower clock in order to save electrical power. For example, when processing documents, the external clock of the CPU can be adjusted to 66 MHz or less to reduce electrical consumption in order to extend the lifetime of the battery of the notebook computer.

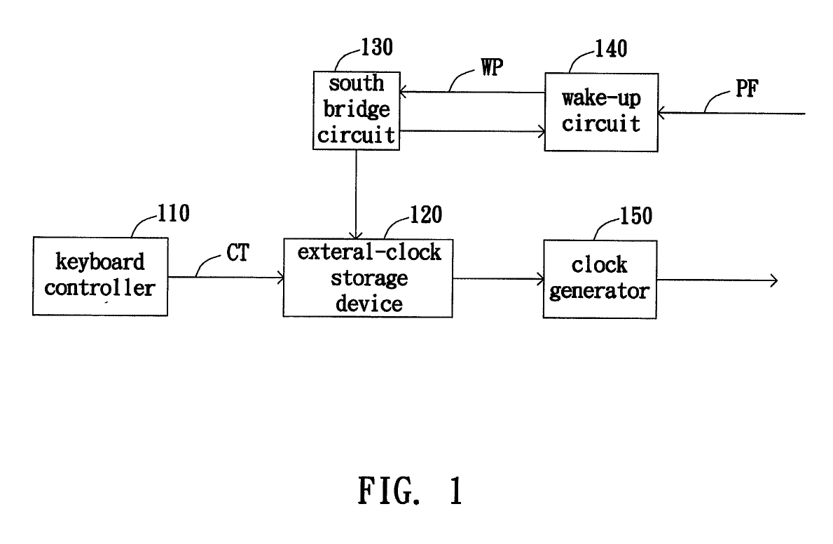

FIG. 1 shows a block diagram of a circuit for adjusting the external clock of a CPU according to a preferred embodiment of the invention. When a user starts the computer, the external clock of the CPU in the computer can be altered by the basic input/output system (BIOS). Also, while the computer is in operation for a long duration, the user can alter the external clock of the CPU by an application executed in the operating system (for example, Windows) of the computer.

When it is necessary to adjust the external clock, the user inputs an external-clock value (for example, 66 or 33) by means of the keyboard. In the meantime, the keyboard controller 110 feeds the control signal CT, corresponding to the external-clock value, into the external-clock storage device 120 to store the external-clock value. Next, the south bridge circuit 130 starts an external-clock altering procedure and a series of shutdown procedures. And after those procedures finish, the computer system is turned off by the shutdown signal PF.

Additionally, as the shutdown signal PF is generated, it is simultaneously fed into the wake-up circuit 140 to start the wake-up circuit 140. Next, the wake-up circuit 140 feeds the wake-up signal WP into the south bridge circuit 130 to wake up the south bridge circuit 130 in a wake-up time (for example, one second). Furthermore, the south bridge circuit 130 reboots the computer system. Afterward the external-clock storage device 120 feeds the external-clock value into the clock generator 150 and the clock generator 150 provides the operative requirement of the CPU with the external clock according to the external-clock value. And then, after processing a series of booting procedures, the operating system is rebooted and the procedure of adjusting the external clock is finished.

The circuit and operating method for adjusting the external clock of a CPU disclosed in the above preferred embodiment of the invention allows users to decrease the clock of the CPU in order to increase the power efficiency when processing the jobs which do not need high operating speed.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for adjusting the external clock of a central processing unit (CPU), the CPU equipped in a computer system, the computer system at least comprising an external-clock storage device and a south bridge circuit, the method comprising steps of:
setting an external-clock value and storing the external-clock value into the external-clock device;
starting an external-clock altering procedure and turning off the computer system;
waking up the south bridge circuit in a wake-up time;
rebooting the computer system; and
providing the central processing unit with the external clock according to the external-clock value stored in the external-clock storage device.

2. The method according to claim 1, wherein the computer system is a notebook computer.

3. The method according to claim 1, wherein the computer system is a desktop computer.

4. The method according to claim 1, wherein the wake-up time is about one second.

5. The method according to claim 1, wherein the external-clock storage device comprises a plurality of registers.

6. A circuit capable of adjusting the external clock of a CPU equipped in a computer system, comprising:
a keyboard controller for setting an external-clock value of the CPU;
an external-clock storage device coupled to the keyboard controller for storing the external-clock value;
a south bridge circuit for starting an external-clock altering procedure, turning off and turning on the computer system;
a wake-up circuit coupled to the south bridge circuit for waking up the south bridge circuit in a wake-up time after turning off the computer system; and
a clock generator coupled to the external-clock storage device for providing the central processing unit with the external clock according to the external-clock value stored in the external-clock storage device.

7. The circuit according to claim 6, wherein the computer system is a notebook computer.

8. The circuit according to claim 6, wherein the computer system is a desktop computer.

9. The circuit according to claim 6, wherein the wake-up time is about one second.

10. The circuit according to claim 6, wherein the external-clock storage device comprises a plurality of registers.

11. The circuit according to claim 6, wherein the wake-up circuit comprises resisters and capacitors (RC) circuit.
